(19) United States
(12) Patent Application Publication
(10) Pub. No.: US 2014/0116823 A1
(43) Pub. Date: May 1, 2014

(54) EXTRUDED TABLE FOR A BRAKE SHOE

(71) Applicant: BENDIX SPICER FOUNDATION BRAKE LLC, Elyria, OH (US)

(72) Inventor: Fred W. Berwanger, Edwardsburg, MI (US)

(73) Assignee: Bendix Spicer Foundation Brake LLC, Elyira, OH (US)

(21) Appl. No.: 13/666,564

(22) Filed: Nov. 1, 2012

(51) Int. Cl. F16D 65/08; F16D 65/09; B23P 11/00; F16D 65/827

(52) U.S. Cl. 188/251 A; 188/251 R; 29/428

(57) ABSTRACT

A brake shoe for a drum brake includes an arcuate brake table defining radially inner and outer sides. First and second webs are disposed on the radially inner side of the brake table and configured to support the brake table. One or more brake linings are disposed on the radially outer side of the brake table. In one embodiment, the brake table defines a plurality of fins projecting radially inwardly from the radially inner side of the brake table, each of the plurality of fins having a length in a radial direction. In another embodiment, the brake table is a unitary body and is configured at first and second ends and a point intermediate the first and second ends to engage first and second brake linings and prevent circumferential movement of the first and second brake linings relative to the brake table. The brake table may comprise extruded aluminum.

### BACKGROUND OF THE INVENTION

a. Field of the Invention

This invention relates to drum brakes. In particular, the invention relates to a brake shoe for a drum brake in which a brake table of the shoe is formed through extrusion and includes features for reducing operating temperatures of the brake linings and for improved retention and easier replacement of the brake linings.

b. Background Art

A conventional drum brake includes a brake drum that rotates with a wheel or wheels proximate to one end of an axle. The drum defines a radially inner braking surface. A brake spider is disposed about the axle and a pair of brake shoes are pivotally mounted at one end to the brake spider. The opposite end of each brake shoe is engaged by an actuator such as a cam or hydraulic piston or wedge to move the brake shoes between positions of engagement and disengagement with the braking surface of the brake drum.

The brake shoes include one or more arcuate webs that are coupled to the brake spider and the actuator, a brake table supported by the webs, and one or more brake linings supported on the table and configured for selective engagement with the braking surface of the brake drum. Conventional brake shoes have several drawbacks. First, in a conventional brake shoe, the brake linings are coupled to the brake table with a relatively large number of rivets which makes it difficult to remove and replace the brake linings when they become worn. Further, portions of the linings between the rivets are subjected to relatively high stress in compression, tension, and shear during braking, but some types of linings do not resist stress in tension and shear as well as they do in compression. Second, replacement of the brake linings is required—despite the difficulties noted above—in part due to relatively high operating temperatures that can substantially reduce the life of the brake linings in conventional brake shoes. Third, the brake table and webs in conventional brake shoes are generally made from steel to provide sufficient strength and span stiffness. Rust buildup between the table and linings, however, can result in cracked or broken linings, dragging brakes or excessive noise.

The inventor herein has recognized a need for a brake shoe for a drum brake that will minimize and/or eliminate one or more of the above-identified deficiencies.

### BRIEF SUMMARY OF THE INVENTION

The present invention relates to a brake shoe for a drum brake. In particular, the present invention relates a brake shoe that may be formed by extrusion and that includes features for reducing operating temperatures of the brake linings and/or for improved retention and easier replacement of the brake linings.

A brake shoe for a drum brake in accordance with one embodiment of the present invention includes an arcuate brake table defining a radially inner side and a radially outer side. The brake shoe further includes first and second webs disposed on the radially inner side of the brake table and configured to support the brake table. The brake shoe further includes a brake lining disposed on the radially outer side of the brake table. The brake table defines a plurality of fins projecting radially inwardly from the radially inner side of the brake table, each of the plurality of fins having a length in a radial direction.

A brake shoe for a drum brake in accordance with another embodiment of the present invention includes a brake table defining a radially inner side and a radially outer side. The brake shoe further includes first and second webs disposed on the radially inner side of the brake table and configured to support the brake table. The brake shoe further includes first and second brake linings disposed on the radially outer side of the brake table. The brake table is a unitary body and is configured at first and second ends and a point intermediate the first and second ends to engage the first and second brake linings and prevent circumferential movement of the first and second brake linings relative to the brake table.

A brake shoe for a drum brake in accordance with another embodiment of the present invention includes a brake table defining a radially inner side and a radially outer side. The brake shoe further includes first and second webs disposed on the radially inner side of the brake table and configured to support the brake table. The brake shoe further includes first and second brake linings disposed on the radially outer side of the brake table. The brake table is a unitary body and includes means for inhibiting movement of each of the first and second brake linings relative to the brake table in both a first circumferential direction and a second circumferential direction opposite the first circumferential direction.

A method of manufacturing a brake shoe for a brake drum in accordance with another embodiment of the present invention includes the steps of forcing material through a die to form a brake table and machining the brake table to form a plurality of attachment features. The method further includes the steps of coupling the brake table to first and second webs using the plurality of attachment features and attaching at least one brake lining to the brake table.

A brake shoe in accordance with the present invention represents an improvement relative to conventional brake shoes. By forming the brake table in such a way that it is configured to prevent circumferential movement of the brake linings relative to the brake table as in one or more of the above-described embodiments, the brake linings may be attached to the brake table with fewer fasteners. As a result, easier removal and replacement of worn linings is facilitated. Further, the linings may be attached in a manner to reduce stress in tension and shear during a brake application. By forming the brake table with fins and/or materials having high specific heats and thermal conductivity as in one or more of the above-described embodiments, the operating temperatures on the linings may be reduced thereby reducing wear and frequency of replacement. Further, the use of different, corrosion resistant materials for the brake table enables a reduction in rust buildup between the table and linings thereby increasing the life of the brake linings and reducing brake drag and excessive noise.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a plan view of a conventional drum brake.

FIG. 2 is a perspective view of a brake shoe in accordance with one embodiment of the present invention

FIG. 3 is a plan view of the brake shoe of FIG. 2.

FIG. 4 is a plan view the brake table of the brake shoe of FIG. 2.

FIG. 5 is a plan view of a brake shoe in accordance with another embodiment of the present invention.

FIG. 6 is a plan view the brake table of the brake shoe of FIG. 5.

FIG. 7 is a flow chart illustrating a method for manufacturing a brake shoe for a drum brake in accordance with one embodiment of the present invention.

### DETAILED DESCRIPTION OF THE INVENTION

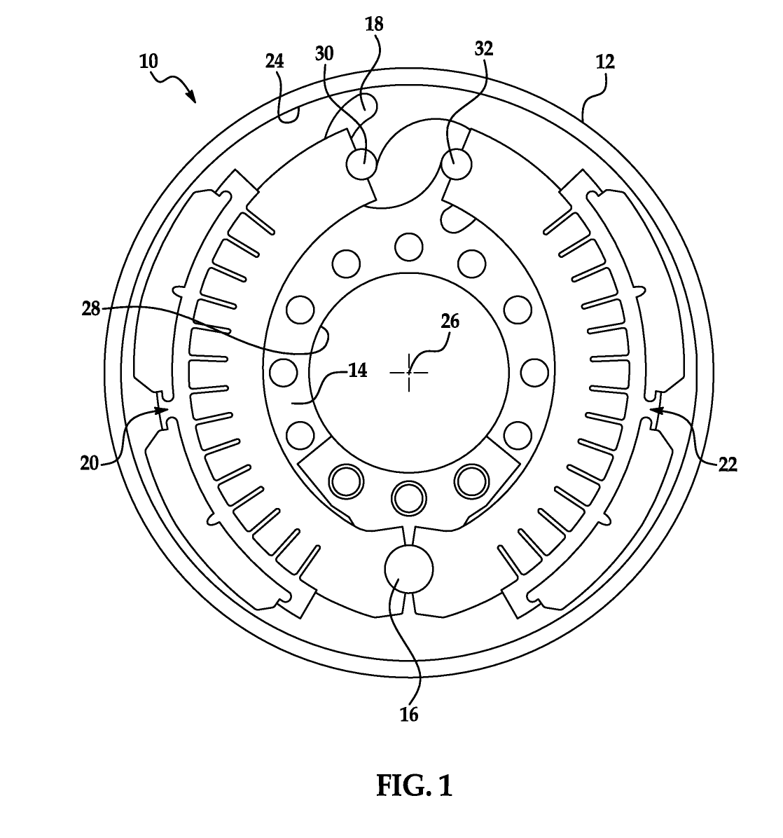

Referring now to the drawings wherein like reference numerals are used to identify identical components in the various views, FIG. 1 illustrates a drum brake 10. Brake 10 is particularly adapted for use in heavy trucks. It should be understood, however, that brake 10 may be used on a wide variety of vehicles and in non-vehicular applications. Brake 10 may include a brake drum 12, a brake spider 14, an anchor 16, an actuating member 18, and brake shoes 20, 22 in accordance with the present invention.

Brake drum 12 provides a braking surface 24 and is conventional in the art. Drum 12 may be made from conventional metals and metal alloys such as steel or cast iron. Drum 12 is annular and rotates with the vehicle wheel or wheels at one end of an axle about a central axis 26 extending through the axle (and into and out of drawing in FIG. 1).

Brake spider 14 is provided to mount the various components of brake 10. Spider 14 defines a central aperture 28 through which the vehicle axle may extend. Spider 14 also supports anchor 16 on one side of the axle and may further include an aperture on a diametrically opposite side of the axle through which a camshaft (not shown) supporting actuating member 18 extends.

Anchor 16 is provided to pivotally mount brake shoes 20, 22. Anchor 16 is conventional in the art and is supported on spider 14. Anchor 16 may comprise a round pin that extends axially from spider 14. In the illustrated embodiment, a single anchor 16 is used to pivotally mount brake shoes 20, 22. It should be understood, however, that separate anchors 16 could be used to mount each brake shoe 20, 22.

Actuating member 18 is provided to cause movement of brake shoes 20, 22 between positions of engagement with and disengagement from braking surface 24 of drum 12. In the illustrated embodiment, actuating member 18 comprises a conventional doubled lobed S-cam. Cam followers 30, 32 coupled to one end of brake shoes 20, 22 follow the surface of actuating member 18 as it rotates thereby causing shoes 20, 22 to pivot about anchor 16. Although actuating member 18 comprises an S-cam in the illustrated embodiment, it should be understood that conventional fluid actuated pistons or a wedge type mechanism may also be employed to move shoes 20, 22 between positions of engagement with and disengagement from braking surface 24.

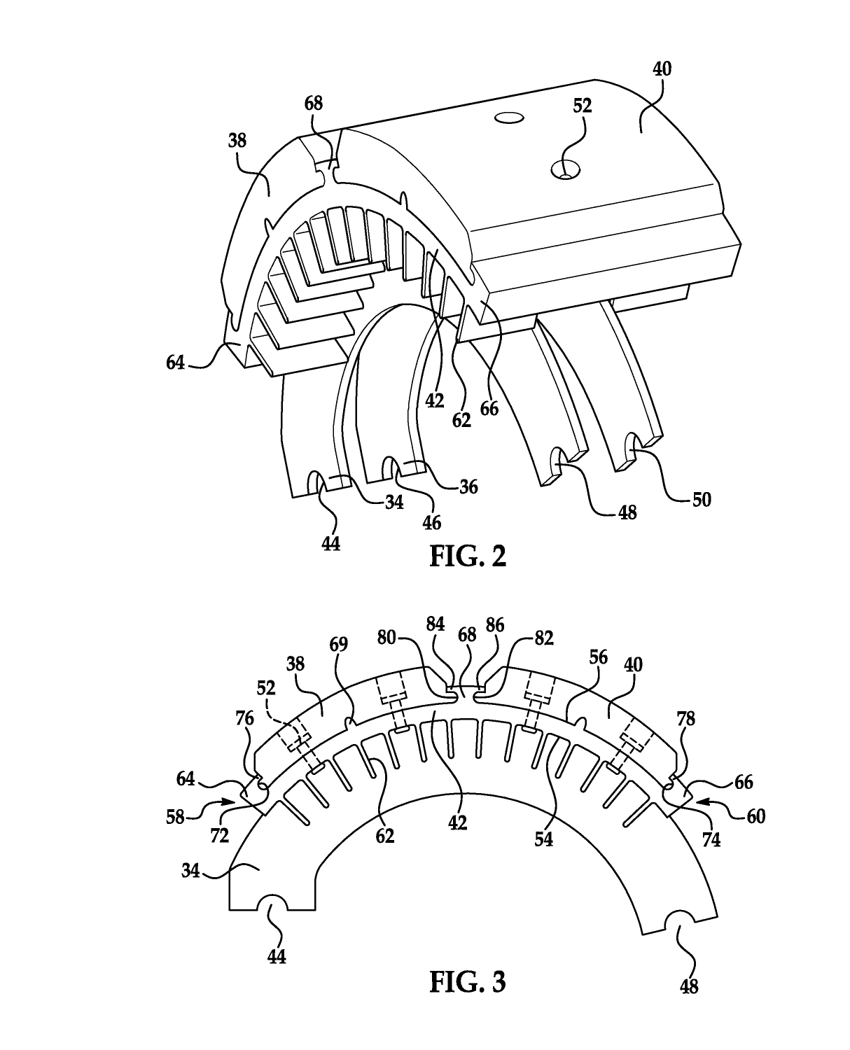

Brake shoes 20, 22 are provided for selective engagement with braking surface 24 of drum 12 in order to apply a braking torque to drum 12 and one or more wheels. Referring now to FIGS. 2-4, brake shoes 20, 22 in accordance with one embodiment of the invention may each include a pair of spaced webs 34, 36 (best shown in FIG. 2), one or more brake linings 38, 40, and a brake table 42.

Webs 34, 36 are provided to support brake table 42 and may extend generally parallel to one another. Webs 34, 36 may be made from metals and metal alloys and, in particular, may comprise steel. Webs 34, 36 are arcuate in shape and may define semicircular recesses 44, 46 at one end configured to receive anchor 16. Webs 34, 36 may further define aligned slots 48, 50 at an opposite end configured to receive a corresponding cam follower 30, 32. Webs 34, 36 may also provide a connection point for retainer springs (not shown) used to retain brake shoes 20, 22 in engagement with anchor 16 and return springs (not shown) used to bias brake shoes 20, 22 to a position of disengagement from braking surface 24.

Brake linings 38, 40 are provided for frictional engagement with braking surface 24 of drum 12. Linings 38, 40 may be made from conventional friction materials. Brake linings 38, 40 may be secured to brake table 42 using one or more fasteners. In accordance with one aspect of the present invention, linings 38, 40 may be secured to table 42 using one or more threaded fasteners 52 to facilitate removal and replacement of worn linings 38, 40. Brake linings 38, 40 are shaped at either circumferential end complementary to the shape of brake table 42 for a purpose described hereinbelow. Although the illustrated embodiment shows the use of multiple brake linings 38, 40, it should be understood that a single brake lining could alternatively be used in connection with various embodiments of the invention.

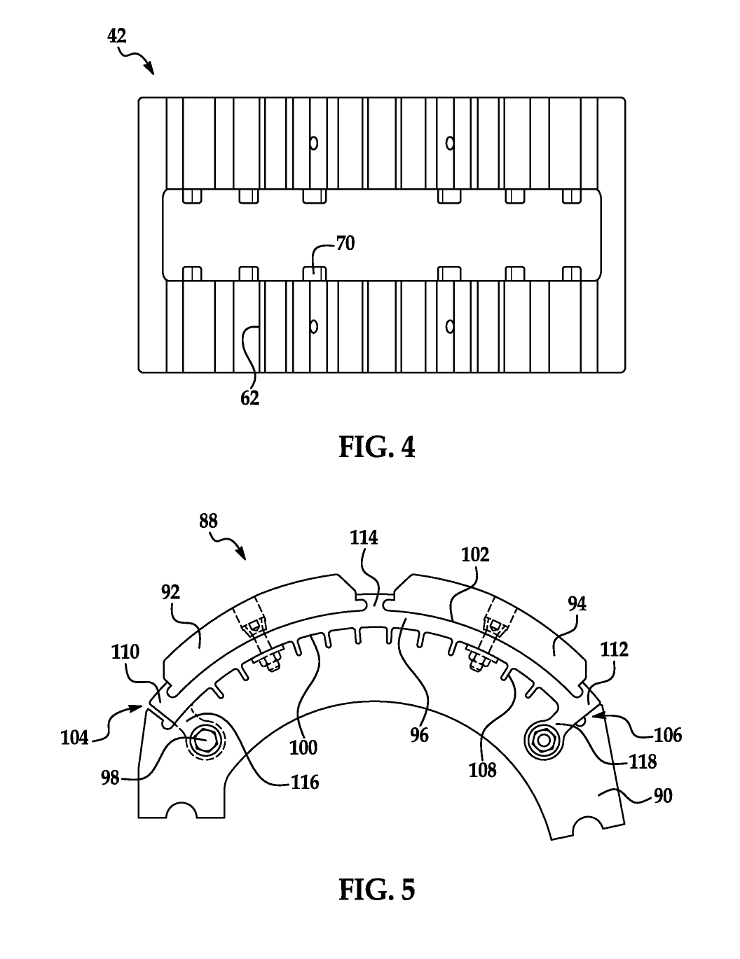

Brake table 42 is provided to support brake linings 38, 40. In accordance with one aspect of the present invention, table 42 may be made from materials having a relatively high specific heat, high thermal conductivity and low density such as aluminum or an aluminum alloy. Table 42 may be formed by extrusion. Alternatively, table 42 may be formed as a unitary casting with webs 34, 36. Table 42 is arcuate and may comprise a unitary body. Table 42 has a radially inner side 54, a radially outer side 56 and circumferential ends 58, 60. In accordance with various aspects of the present invention, table may include cooling fins 62, means, such as retention features 64, 66, 68, for inhibiting movement of each of brake linings 38, 40 relative to brake table 42 in one or more directions, means, such as ridges 69, for transmitting force from linings 38, 40 to brake table 42, and means, such as slots 70 (see FIG. 4), configured to receive corresponding deformable tabs (not shown) on webs 34, 36 for coupling brake table 42 to webs 34, 36.

Fins 62 cool brake shoes 20, 22 by transmitting heat away from linings 38, 40 through table 42. Fins 62 project from side 54 of brake table 42. Referring to FIG. 4, fins 62 may be disposed on the outboard sides of each web 34, 36, extending from the web 34 or 36 to an outboard edge of table 42. Fins 62 on opposite sides of the table 42 may be axially aligned with one another. Referring to FIG. 3, in cross-section fins 62 have a length in a radial direction and a width in a circumferential direction that is substantially uniform over at least a portion of the length and, in the illustrated embodiment, substantially all of the length. It should be understood that the number of fins may vary.

Retention features 64, 66, 68 provide a means for inhibiting movement of brake linings 38, 40 relative to brake table 42 in one or more directions. Retention features 64, 66, 68 transfer most of the braking torque from linings 38, 40 to table 42 reducing the number of fasteners required to secure linings 38, 40 to table 42. Retention features 64, 66, 68 are disposed on the radially outer side 56 of table 42 and may have a shape that is complementary to the shape of linings 38, 40. Retention features 64, 66 are disposed at circumferential ends 58, 60 of table 42. In the illustrated embodiment features 64, 66 each define a recess 72, 74 configured to receive a portion of a corresponding lining 38, 40 and a lip 76, 78, respectively, that is disposed radially outwardly of the portion of the lining 38, 40 received in the recess 72, 74. Feature 64 inhibits movement of lining 38 in one circumferential direction (counterclockwise in FIG. 3) and in a radially outward direction. Feature 66 inhibits movement of lining 40 in an opposite circumferential direction (clockwise in FIG. 3) and in a radially outward direction. Feature 68 is disposed intermediate to ends 58, 60 of table 42 and may be disposed at a circumferential midpoint of table 42. In the illustrated embodiment feature 68 defines a pair of opposed recesses 80, 82, configured to receive a portion of linings 38, 40, respectively, and lips 84, 86, respectively, that are disposed radially outwardly of the portion of the lining 48, 40 received in the recess 80, 82. Feature 68 inhibits movement of lining 38 in one circumferential direction (clockwise in FIG. 3) and in a radially outward direction and inhibits movement of lining 40 in another circumferential direction (counterclockwise in FIG. 3) and in a radially outward direction. It should be understood that the shape of features 64, 66, 68 may vary.

Ridges 69 provide a means for transmitting force from brake linings 38, 40 into table 42. Ridges 69 extend radially outwardly from outer side 56 of brake table 42. One ridge 69 may be disposed midway between retention features 64 and 68 and another ridge 69 may be disposed midway between retention features 66 and 68. It should be understood, however, that the number and placement of ridges 69 may vary. Ridges 69 may be shaped complementary to the shape of corresponding channels formed in the radially inner surface of linings 38, 40.

Slots 70 provide a means for coupling table 42 to webs 34, 36. Slots 70 are configured to receive plastically deformable tabs (not shown) extending from webs 34, 36. The tabs are movable between a position of disengagement with table 42 to a position of engagement with table 42. The tabs may, for example, extend through slots 70 in webs 34, 36 and be deformed to prevent relative movement between webs 34, 36 and table 42.

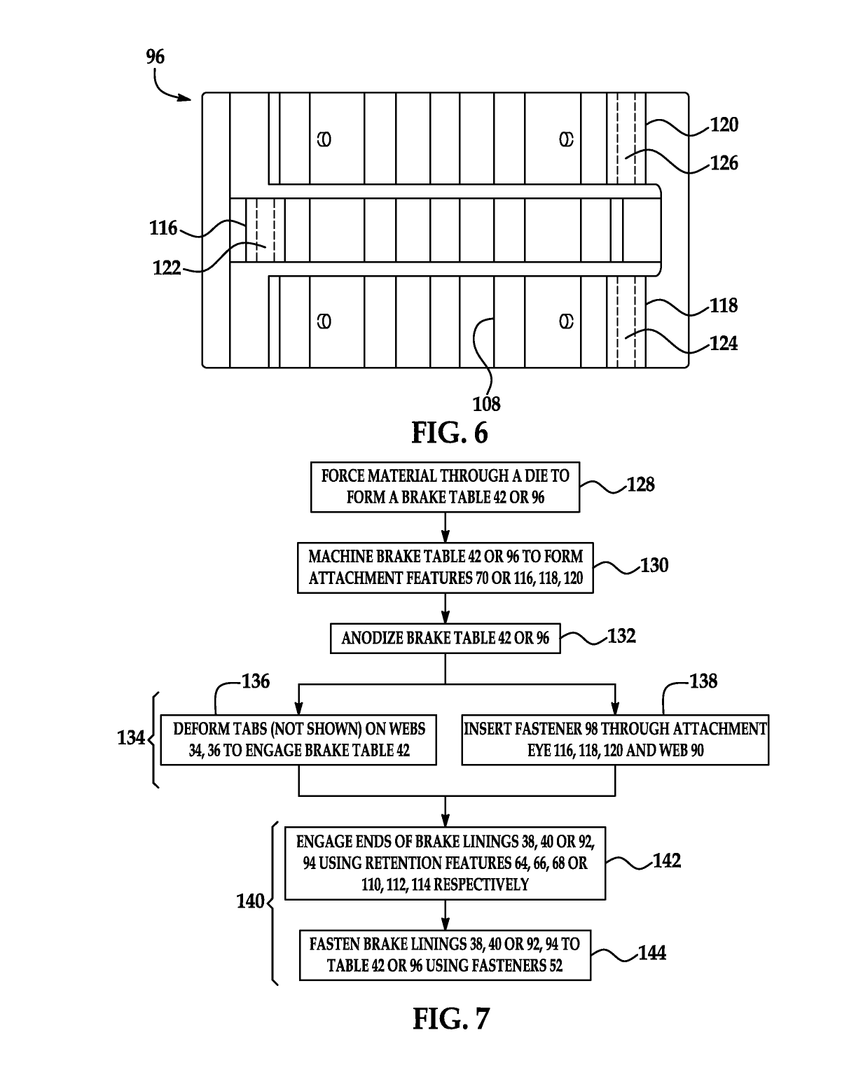

Referring now to FIGS. 5-6, a brake shoe 88 in accordance with another embodiment of the invention includes a pair of spaced webs 90 (only one of which is shown), one or more brake linings 92, 94, and a brake table 96.

Webs 90 and linings 92, 94 are substantially similar to webs 34, 36 and linings 38, 40 described hereinabove. Webs 90, however, may include apertures configured to receive fasteners 98, such as bolts or rivets for a purpose described hereinbelow.

Brake table 96 is provided to support brake linings 92, 94. In accordance with one aspect of the present invention, table 96 may again be made from materials having a relatively high specific heat, high thermal conductivity and low density such as aluminum or an aluminum alloy. Table 96 is arcuate and may comprise a unitary body. Table 96 has a radially inner side 100, a radially outer side 102 and circumferential ends 104, 106. In accordance with various aspects of the present invention, table may include cooling fins 108, means, such as retention features 110, 112, 114 for inhibiting movement of each of brake linings 92, 94 relative to brake table 96 in one or more directions, and means, such as attachment eyes 116, 118, 120 for coupling brake table 96 to webs 90.

Fins 108 are substantially similar to fins 62 described hereinabove and project radially inwardly from side 100 of table 96. In addition to being located on the outboard sides of webs 90 however, fins 108 may also be disposed on the inboard side of webs 90 (i.e. between the two webs 90). Fins 108 on the opposite sides of each web 90 may be axially aligned with one another such that fins 108 extend across the axial length of the table broken only by webs 90.

Retention features 110, 112, 114 are substantially similar to features 64, 66, 68. Accordingly, reference may be had to the description of reference features 64, 66, 68 hereinabove.

Attachment eyes 116, 118, 120 provide a means for coupling table 96 to webs 90. Attachment eyes 116, 118, 120 are disposed on the radially inner side 100 of table 96 and extend radially inwardly. Attachment eye 116 may be disposed proximate end 104 of table 96 and may be disposed on the inboard side of webs 90 (i.e. between webs 90). Attachment eyes 118, 120 may be disposed proximate end 106 of table 96 and may be disposed on the outboard sides of webs 90. It should be understood, however, that the location of attachment eyes 116, 118, 120 on table 96 and relative to webs 90 may vary. Referring to FIG. 6, attachment eyes 116, 118, 120 define bores 122, 124, 126 configured to align with corresponding bores in webs 90 and configured to receive fasteners 98 such as bolts or rivets extending therethrough to couple table 96 to webs 90.

Referring now to FIG. 7, a method of manufacturing a brake shoe 20, 22 or 88 for a drum brake 10 in accordance with one embodiment of the present invention will be described. The method may begin with the step 128 of forcing a material through a die to form a brake table 42 or 96 (i.e. an extrusion process). As stated hereinabove, the material may comprise a material having a relatively high specific heat, high thermal conductivity and low density such as aluminum or an aluminum alloy. The table 42 or 96 may comprise a unitary body. Step 128 may result in a table 42 or 96 having a plurality of fins 62 or 108, respectively, and/or retention features 64, 66, 68 or 110, 112, 114, respectively. Step 128 may result in the simultaneous formation of a plurality of tables as a single block of tables. Accordingly, the method may include the step (not shown) of cutting the block of tables to obtain individual brake tables 42 or 96. The method may continue with the steps 130, 132 of machining the brake table 42 or 96 to form a plurality of attachment features such as slots 70 or attachment eyes 116, 118, 120 and anodizing table 42 or 96 to prevent corrosion at the interface between table 42 or 96 and corresponding linings 38, 40 or 92, 94. The method may continue with the step 134 of coupling the brake table 42 of 96 to the webs 34, 36 or 90, respectively, using the attachment features. In the case of brake table 42, step 134 may include the substep 136 of deforming tabs from a position of disengagement with brake table 42 to a position of engagement with brake table 42. In the case of brake table 96, step 134 may include the substep 138 of inserting a fastener 98 through an attachment eye 116, 118, 120 and one or more webs 90. The method may conclude with the step 140 of attaching at least one brake lining 38, 40 or 92, 94 to the brake table 42 or 96. Step 140 may include the substep 142 of engaging the circumferential ends of the brake linings 38, 40 or 92 94 with the retention features 64, 66, 68 or 110, 112, 114 respectively on the a corresponding brake table 42 or 96. Step 140 may further include the substep 144 of fastening the brake linings 38, 40 or 92, 94 to the brake table 42 or 96 using a threaded fastener 52.

A brake shoe 20, 22 or 88 in accordance with the present invention represents an improvement relative to conventional brake shoes. By forming the brake table 42 or 96 in such a way that it is configured to prevent circumferential movement of the brake linings 38, 40 or 92, 94 relative to the brake table 42 or 96 as in one or more of the above-described embodiments, the brake linings 38, 40 or 92, 94 may be attached to the brake table with fewer fasteners. As a result, easier removal and replacement of worn linings is facilitated. Further, the linings 38, 40 or 92, 94 may be attached in a manner to reduce stress in tension and shear. By forming the brake table 42 or 96 with fins 62 or 108 and/or materials having high specific heats and thermal conductivity as in one or more of the above-described embodiments, the operating temperatures on the linings 38, 40 or 92, 94 may be reduced thereby reducing wear and frequency of replacement. This benefit would be greatest during relatively short periods in which brakes are applied repeatedly and the brake tables 42, 96 and linings 38, 40, 92 94 are maintained at elevated temperatures. The use of different, corrosion resistant materials for the brake table 42 or 96 instead of conventional steel will also enable a reduction in rust buildup between the table 42 of 96 and linings 38, 40 or 92, 94 as the friction material itself may include galvanically incompatible metals that promote rust thereby increasing the integrity of the brake linings 38, 40 or 92, 94 and reducing brake drag and excessive noise.

While the invention has been shown and described with reference to one or more particular embodiments thereof, it will be understood by those of skill in the art that various changes and modifications can be made without departing from the spirit and scope of the invention.

What is claimed is:

1. A brake shoe for a drum brake, comprising:
an arcuate brake table defining a radially inner side and a radially outer side;
first and second webs disposed on said radially inner side of said brake table and configured to support said brake table; and,
a first brake lining disposed on said radially outer side of said brake table
wherein said brake table defines a plurality of fins projecting radially inwardly from said radially inner side of said brake table, each of said plurality of fins having a length in a radial direction.

2. The brake shoe of claim 1 wherein a width in a circumferential direction of each of said plurality of fins is substantially uniform over a portion of said length.

3. The brake shoe of claim 1 wherein a first set of said plurality of fins are disposed between said first and second webs.

4. The brake shoe of claim 3 wherein a second set of said plurality of fins are disposed on an opposite side of one of said first and second webs relative to said first set of said plurality of fins.

5. The brake shoe of claim 1 wherein a first set of said plurality of fins are disposed on an outboard side of said first web and a second set of said plurality of fins are disposed on an outboard side of said second web.

6. The brake shoe of claim 5, wherein a third set of said plurality of fins are disposed between said first and second webs.

7. The brake shoe of claim 1 wherein said brake table defines a first attachment eye extending radially inwardly, said first attachment eye configured to receive a first fastener extending through said first attachment eye and one of said first and second webs.

8. The brake shoe of claim 7 wherein said first attachment eye is disposed between said first and second webs and said first fastener extends through said first attachment eye and both of said first and second webs.

9. The brake shoe of claim 7 wherein said first attachment eye is disposed proximate a first end of said brake table and said brake table defines a second attachment eye proximate said first end of said brake table and extending radially inwardly, said second attachment eye configured to receive a second fastener extending through said second attachment eye and another of said first and second webs.

10. The brake shoe of claim 9 wherein said brake table defines a third attachment eye proximate a second end of said brake shoe and extending radially inwardly, said third attachment eye disposed between said first and second webs and configured to receive a third fastener extending through said third attachment eye and both of said first and second webs.

11. The brake shoe of claim 1, further comprising a second brake lining disposed on said radially outer side of said brake table and wherein said brake table is a unitary body and is configured at first and second ends and a point intermediate said first and second ends to engage said first and second brake linings and prevent circumferential movement of said first and second brake linings relative to said brake table.

12. The brake shoe of claim 11 wherein said brake table is further configured at said first and second ends and at said point intermediate said first and second ends to prevent radial movement of said first and second brake linings relative to said brake table.

13. The brake shoe of claim 1, further comprising a second brake lining disposed on said radially outer side of said brake table and wherein said brake table is a unitary body and includes means for inhibiting movement of each of said first and second brake linings relative to said brake table in both a first circumferential direction and a second circumferential direction opposite said first circumferential direction.

14. The brake shoe of claim 1 wherein said brake table comprises a first material and said first and second webs comprise a second material different than said first material.

15. The brake shoe of claim 1 wherein said brake table comprises aluminum.

16. The brake shoe of claim 15 wherein said first and second webs comprise steel.

17. A brake shoe for a drum brake, comprising:
a brake table defining a radially inner side and a radially outer side;
first and second webs disposed on said radially inner side of said brake table and configured to support said brake table; and,
first and second brake linings disposed on said radially outer side of said brake table
wherein said brake table is a unitary body and is configured at first and second ends and a point intermediate said first and second ends to engage said first and second brake linings and prevent circumferential movement of said first and second brake linings relative to said brake table.

18. The brake shoe of claim 17 wherein said brake table has a shape at said first end and at said point intermediate said first and second ends that is complementary to a shape of said first brake lining and a shape at said second end and at said point intermediate said second end that is complementary to a shape of said second brake lining.

19. The brake shoe of claim 17 wherein said brake table is further configured at said first and second ends and at said point intermediate said first and second ends to prevent radial movement of said first and second brake linings relative to said brake table.

20. The brake shoe of claim 17 wherein said brake table comprises aluminum.

21. A brake shoe for a drum brake, comprising:
a brake table defining a radially inner side and a radially outer side;
first and second webs disposed on said radially inner side of said brake table and configured to support said brake table; and,
first and second brake linings disposed on said radially outer side of said brake table
wherein said brake table is a unitary body and includes means for inhibiting movement of each of said first and second brake linings relative to said brake table in both a first circumferential direction and a second circumferential direction opposite said first circumferential direction.

22. The brake shoe of claim 21 wherein said inhibiting means includes:
a first retention feature disposed at a first end of said brake table and configured to prevent movement of said first brake lining in said first circumferential direction;
a second retention feature disposed at a second end of said brake table and configured to prevent movement of said second brake lining in said second circumferential direction
a third retention feature intermediate said first and second ends of said brake table and configured to prevent movement of said first brake lining in said second circumferential direction and movement of said second brake lining in said first circumferential direction.

23. The brake shoe of claim 21 wherein said brake table comprises aluminum.

24. A method of manufacturing a brake shoe for a drum brake, comprising the steps of:
forcing a first material through a die to form a brake table;
machining said brake table to form a plurality of attachment features;
coupling said brake table to first and second webs using said plurality of attachment features; and,
attaching at least one brake lining to said brake table.

25. The method of claim 24, wherein said attaching step includes the substep of fastening said at least one brake lining to said brake table using a threaded fastener.

26. The method of claim 24 wherein one of said attachment features comprises a first attachment eye extending radially inwardly from said brake table and said coupling step includes the substep of inserting a fastener through said first attachment eye and said first web.

27. The method of claim 24 wherein said first and second webs comprise a second material different than said first material.

28. The method of claim 24 wherein said brake table comprises aluminum.

29. The method of claim 28 wherein said first and second webs comprise steel.

30. The method of claim 24 wherein said die creates a plurality of fins projecting radially inwardly from a radially inner side of said brake table.

31. The method of claim 24 wherein said die creates means for inhibiting movement said at least one brake lining relative to said brake table in both a first circumferential direction and a second circumferential direction opposite said first circumferential direction.
